(19) United States
(12) Patent Application Publication
(10) Pub. No.: US 2016/0154286 A1
(43) Pub. Date: Jun. 2, 2016

(54) LIQUID CRYSTAL DISPLAY DEVICE AND METHOD OF MANUFACTURING THE SAME

(71) Applicant: Samsung Display Co., Ltd., Yongin-City (KR)

(72) Inventors: Yang Ho JUNG, Seoul (KR); Hoon KANG, Suwon-si (KR); Chul Won PARK, Gwangmyeong-si (KR); Koichi SUGITANI, Hwaseong-si (KR); Jin Ho JU, Seoul (KR)

(21) Appl. No.: 14/800,073

(22) Filed: Jul. 15, 2015

(30) Foreign Application Priority Data
Nov. 28, 2014 (KR) 10-2014-0168659

(51) Int. Cl. G02F 1/1362; G02F 1/1339; G02F 1/1368

(52) U.S. Cl. CPC G02F 1/136286; G02F 1/1368; G02F 1/136209; G02F 1/13394; G02F 2001/136222

(57) ABSTRACT

A liquid crystal display device includes: an insulating substrate, a thin film transistor positioned on the insulating substrate, a pixel electrode connected to the thin film transistor, a pillar portion positioned on the pixel electrode, a common electrode positioned on the pillar portion, a liquid crystal layer filling in a cavity positioned between the pixel electrode, the pillar portion, and the common electrode and containing liquid crystal molecules, and a roof layer and an overcoat positioned on the common electrode, wherein a cross section of the cavity in a column direction is reversely tapered.

### CROSS-REFERENCE TO RELATED APPLICATION

This application claims priority to and the benefit of Korean Patent Application No. 10-2014-0168659 filed in the Korean Intellectual Property Office on Nov. 28, 2014, the entire contents of which are incorporated herein by reference.

### BACKGROUND

(a) Field

The present invention relates to a liquid crystal display device and a method of manufacturing the same.

(b) Description of the Related Art

A display device is required in computer monitors, televisions, mobile phones, and the like, which are widely used at this time. As the display device, there are a cathode ray tube display device, a liquid crystal display device, a plasma display device, and the like.

The liquid crystal display device, which is one of flat panel display devices most widely used at present, is composed of two display panels in which electric field generating electrodes, such as a pixel electrode and a common electrode, are formed and a liquid crystal layer interposed there between. Images are displayed thereon by applying a voltage to the electric field generating electrode to form an electric field in the liquid crystal layer, determining alignment of liquid crystal molecules of the liquid crystal layer through the electric field, and controlling polarization of incident light.

Two display panels constituting the liquid crystal display device may be composed of a thin film transistor array panel and a facing display panel. A gate line transmitting a gate signal and a data line transmitting a data signal are formed to intersect each other on the thin film transistor array panel, and a thin film transistor connected to the gate line and the data line, and a pixel electrode connected to the thin film transistor, and the like, may be formed. A light blocking member, a color filter, a common electrode, and the like, may be formed on the facing display panel. In some cases, the light blocking member, the color filter, and the common electrode may be formed on the thin film transistor array panel.

However, because two substrates are essentially used in the liquid crystal display device according to the related art, and each constituent component is formed on the two substrates, there are problems in that the display device is heavy, thick, and expensive, and a process time is long, etc.

The above information disclosed in this Background section is only for enhancement of understanding of the background of the disclosure and therefore it may contain information that does not form the prior art that is already known to a person of ordinary skill in the art.

### SUMMARY

A liquid crystal display device having advantages of decreasing a weight, a thickness, a cost, and a process time by using a single substrate, and a method of manufacturing the same are provided.

In addition, a liquid crystal display device having a uniform and constant liquid crystal injection cavity through a negative photo resist having heat resistance and improved residue removal characteristics are provided.

A liquid crystal display device includes: an insulating substrate, a thin film transistor positioned on the insulating substrate, a color filter and a light blocking member positioned on the thin film transistor, a pixel electrode positioned on the color filter and connected to the thin film transistor, a pillar portion positioned on the pixel electrode, a common electrode positioned on the pillar portion, a liquid crystal layer filling in a cavity positioned between the pixel electrode, the pillar portion, and the common electrode and containing liquid crystal molecules, and a roof layer and an overcoat positioned on the common electrode, wherein a cross section of the cavity in a column direction is reversely tapered.

A single pixel may include the thin film transistor and the pixel electrode, the thin film transistor may be connected to a gate line and a data line that are insulated from and intersect each other, and the pillar portion may be positioned along the data line in the single pixel.

A cross section of the pillar portion in the column direction may be tapered.

The common electrode and the pixel electrode may be spaced apart and separated from each other by the pillar portion.

A material of the pillar portion may contain a compound in which compounds represented by the following Chemical Formula 1 are connected to each other.

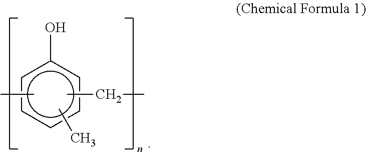

Materials of the pillar portion and the roof layer may be different from each other.

In another aspect, a method of manufacturing a liquid crystal display device includes: forming a thin film transistor on an insulating substrate, forming a pixel electrode connected to the thin film transistor, forming a sacrificial layer on the pixel electrode, performing primary light irradiation on a region of the sacrificial layer to become a pillar portion, heating an entire surface of the sacrificial layer, depositing a conductor on the sacrificial layer, forming a roof layer including an injection hole on the conductor, etching the conductor using the roof layer as a mask to form a common electrode, performing secondary light irradiation on an entire surface of the roof layer, developing the exposed sacrificial layer and injecting liquid crystal molecules through the injection hole, and forming an overcoat covering the roof layer and the injection hole, wherein the pillar portion becomes insoluble by a heating process, and the sacrificial layer except for the pillar portion becomes soluble by the secondary light irradiation.

The sacrificial layer may be a negative photo resist and contain a compound represented by the following Chemical Formula 2.

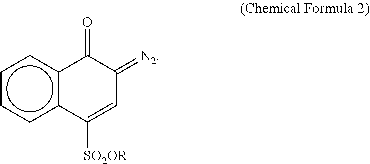

The region to become the pillar portion may become soluble after the primary light irradiation.

The pillar portion may contain a compound represented by the following Chemical Formula 3 by the primary light irradiation.

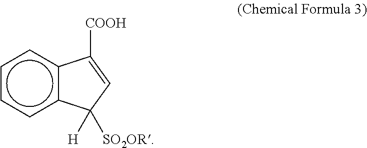

The pillar portion may contain a compound in which compounds represented by the following Chemical Formula 1 are connected to each other by the heating process.

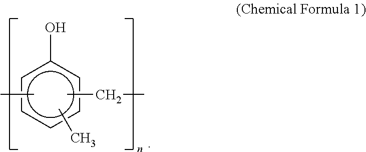

The pillar portion after the heating process may be insoluble.

A material of the pillar portion may not be changed by the secondary irradiation, and the sacrificial layer except for the pillar portion may contain a compound represented by Chemical Formula 3.

The sacrificial layer except for the pillar portion may be soluble.

The sacrificial layer except for the pillar portion may be removed in the developing of the exposed sacrificial layer.

According to an exemplary embodiment, in the liquid crystal display device and the method of manufacturing the same as described above, the display device is manufactured using a single substrate, such that a weight, a thickness, a cost, and a process time may be decreased.

In addition, a uniform and constant liquid crystal injection cavity through a negative photo resist having heat resistance and improved residue removal characteristics may be provided. Therefore, a display device having uniform display quality may be provided.

### BRIEF DESCRIPTION OF THE DRAWINGS

FIG. 1 is a plan layout view of a pixel according to an exemplary embodiment.

FIG. 2 is a cross-sectional view taken along line II-II of FIG. 1.

FIG. 3 is a cross-sectional view taken along line III-III of FIG. 1.

FIGS. 4, 6, 8, and 10 are cross-sectional views taken along line II-II of FIG. 1 according to the process, and FIGS. 5, 7, 9, and 11 are cross-sectional views taken along line III-III of FIG. 1.

### DETAILED DESCRIPTION OF THE EMBODIMENTS

The present disclosure will be described more fully hereinafter with reference to the accompanying drawings, in which exemplary embodiments are shown. As those skilled in the art would realize, the described embodiments may be modified in various different ways, all without departing from the spirit or scope of the present disclosure.

In the drawings, the thicknesses of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

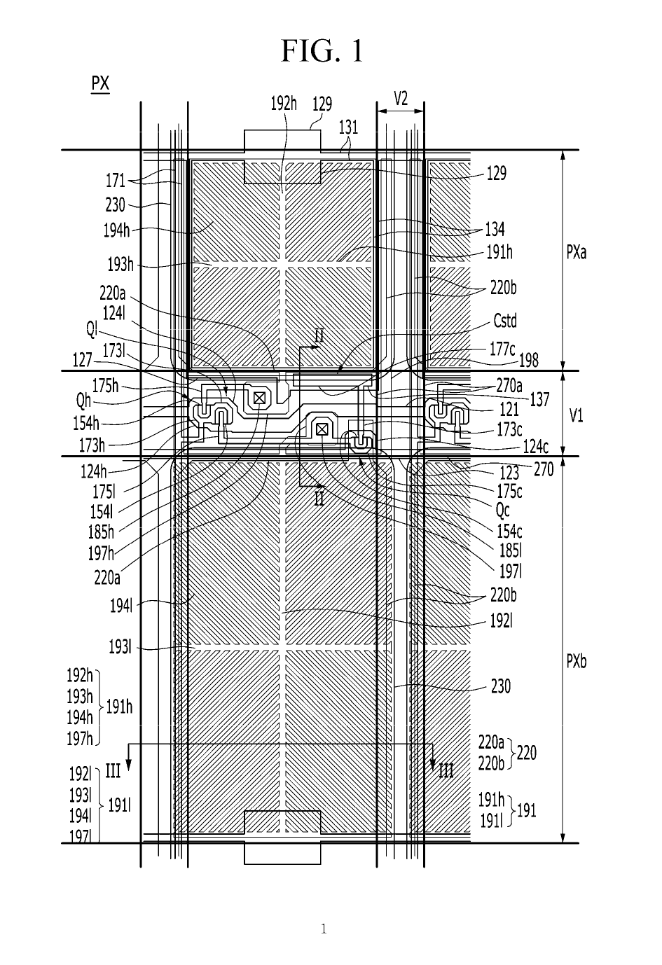

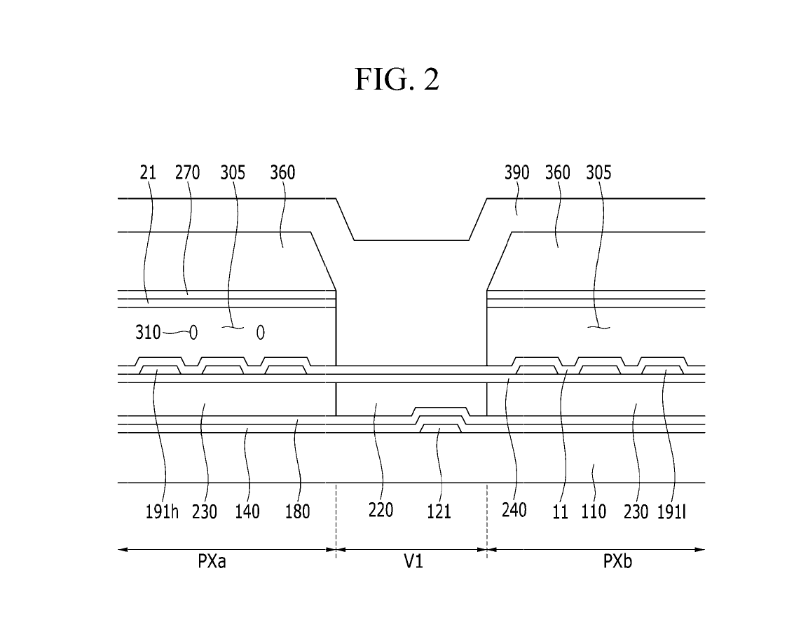

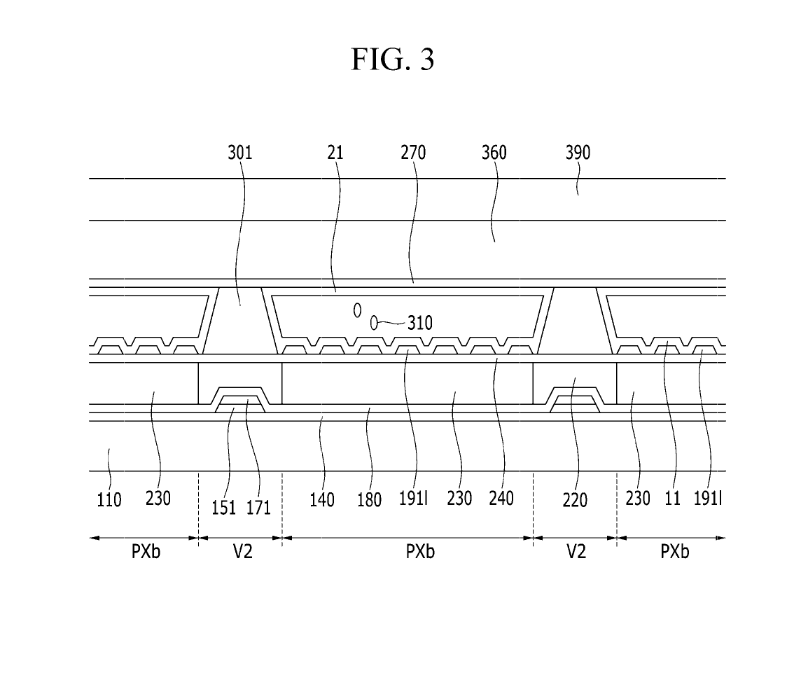

Hereinafter, a liquid crystal display device according to an exemplary embodiment will be described with reference to FIGS. 1 to 3. FIG. 1 is a plan layout view of a pixel according to an exemplary embodiment, FIG. 2 is a cross-sectional view taken along line II-II of FIG. 1, and FIG. 3 is a cross-sectional view taken along line III-III of FIG. 1.

The liquid crystal display device according to an exemplary embodiment includes an insulating substrate 110 schematically made of a material such as glass, plastic, or the like, and a roof layer 360 positioned on the insulating substrate 110.

The insulating substrate 110 includes a plurality of pixels PX. In this case, a single pixel is a unit including a single pixel electrode and a thin film transistor. The plurality of pixels PX are disposed on the insulating substrate 110 in a matrix form including the plurality of pixel rows and a plurality of pixel columns. Each pixel PX may include a first subpixel PXa and a second subpixel PXb. The first and second subpixels PXa and PXb may be disposed in a vertical direction, that is, an extension direction of a data line.

A first valley V1 is positioned between the first and second subpixels PXa and PXb in an extension direction of a gate line, and a second valley V2 is positioned between the plurality of pixel columns. The extension direction of the gate line and the extension direction of the data line may be substantially orthogonal to each other.

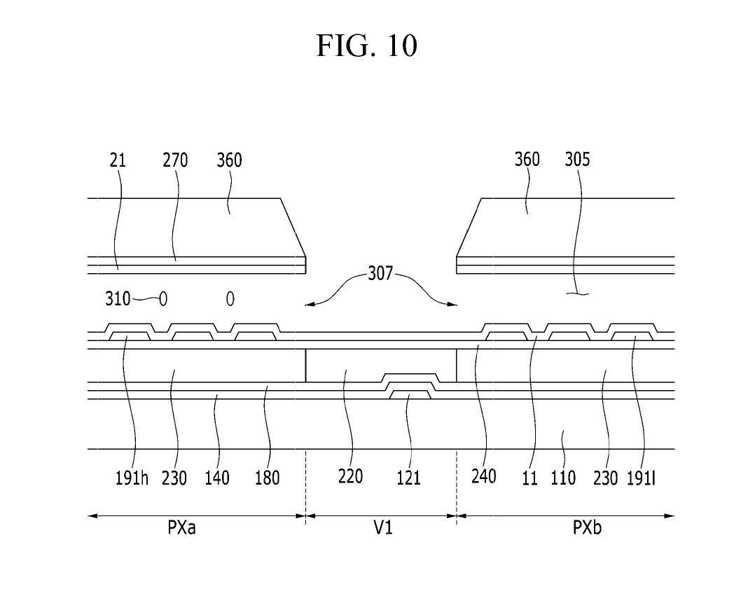

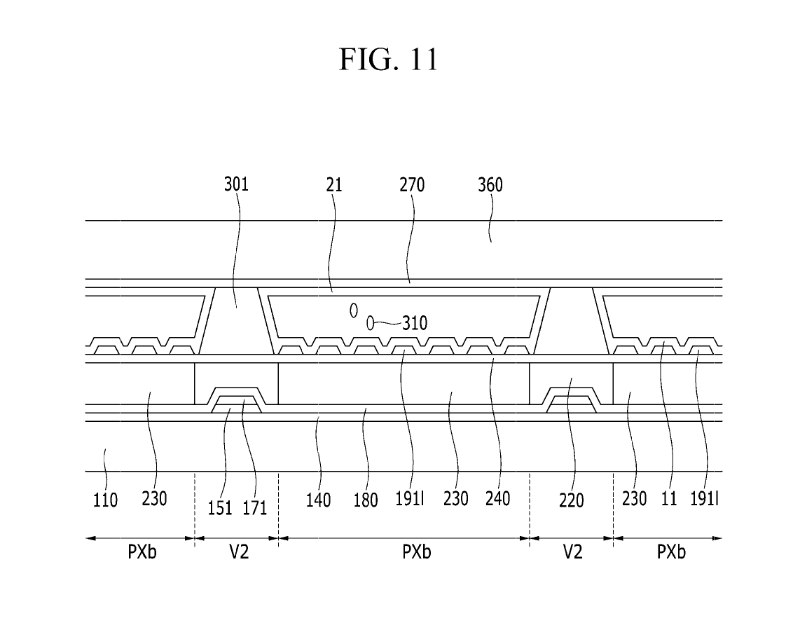

An injection hole 307 (shown in FIG. 10) may be formed in the first valley V1 so that the roof layer 360 is removed and thus, constituent elements positioned below the roof layer 360 are exposed to the outside.

Each roof layer 360 is formed between adjacent second valleys V2 so as to be spaced apart from the substrate 110, such that a space 305 is formed.

A structure of the display device according to an exemplary embodiment as described above is only an example, and may be variously modified. For example, a disposition form of the pixel PX, the first valley V1, and the second valley V2 may be variously changed. For example, a plurality of roof layers 360 may be connected to each other at the first valley V1.

A plurality of gate conductors including a plurality of gate lines 122, a plurality of decompression gate lines 123, and a plurality of storage electrode lines 131 are formed on the insulating substrate 110.

The gate line 121 and the decompression gate line 123 are extended mainly in a horizontal direction (first direction) and transmit gate signals. The gate conductor further includes first and second gate electrodes 124h and 124l protruding upwardly and downwardly from the gate line 121 and a third gate electrode 124c protruding upwardly from the decompression gate line 123. The first and second gate electrodes 124h and 124l are connected to each other to form a single protrusion portion. In this case, protrusion shapes of the first, second and third gate electrodes 124h, 124l, and 124c may be changed.

The storage electrode line 131 is extended mainly in the horizontal direction and transmits a predetermined voltage such as a common voltage Vcom, or the like. The storage electrode line 131 includes storage electrode 129 protruding upwardly and downwardly, a pair of vertical portions 134 extended downwardly so as to be substantially vertical to the gate line 121, and a horizontal portion 127 connecting ends of the pair of vertical portions 134 to each other. The horizontal portion 127 includes a capacity electrode 137 expanded downwardly.

A gate insulating layer 140 is positioned on the gate conductors 121, 123, 124h, 124l, 124c, and 131. The gate insulating layer 140 may be made of an inorganic insulating material such as silicon nitride (SiNx), silicon oxide (SiOx), or the like. In addition, the gate insulating layer 140 may be formed of a single layer or multiple layers.

A first semiconductor layer 154h, a second semiconductor layer 154l, and a third semiconductor layer 154c are positioned on the gate insulating layer 140. The first semiconductor layer 154h may be positioned on the first gate electrode 124h, the second semiconductor layer 154l may be positioned on the second gate electrode 124l, and the third semiconductor layer 154c may be positioned on the third gate electrode 124c. The first semiconductor layer 154h and the second semiconductor layer 154l may be connected to each other, and the second semiconductor layer 154l and the third semiconductor layer 154c may be connected to each other. In addition, the first semiconductor layer 154h may be formed to be extended to a lower portion of the data line 171. The first to third semiconductor layers 154h, 154l, and 154c may be made of amorphous silicon, polycrystalline silicon, metal oxide, or the like.

An ohmic contact (not shown) may be further positioned on each of the first to third semiconductor layers 154h, 154l, and 154c. The ohmic contact may be made of a material such as silicide or n+ hydrogenated amorphous silicon doped with n-type impurity at a high concentration.

A data conductor including a data line 171, a first source electrode 173h, a second source electrode 173l, a third source electrode 173c, a first drain electrode 175h, a second drain electrode 175l, and a third drain electrode 175c is formed on the first to third semiconductor layers 154h, 154l, and 154c.

The data line 171 transmits data signals and is mainly extended in the vertical direction to thereby intersect the gate line 121 and the decompression gate line 123. Each data line 171 includes first and second source electrodes 173h and 173l connected to each other while being extended toward the first and second gate electrodes 124h and 124l.

Each of the first drain electrode 175h, the second drain electrode 175l, and the third drain electrode 175c has one wide end portion and the other bar-type end portion. The bar-type end portions of the first drain electrode 175h and second drain electrode 175l are partially enclosed by the first source electrode 173h and second source electrode 173l. The one wide end portion of the second drain electrode 175l is extended again to thereby form the third source electrode 173c bent in a ‘U’-letter shape. The wide end portion 177c of the third drain electrode 175c overlaps with the capacity electrode 137 to form a decompression capacitor Cstd, and the bar-type end portion thereof is partially enclosed by the third source electrode 173c.

The first gate electrode 124h, the first source electrode 173h, and the first drain electrode 175h form a first thin film transistor Qh together with the first semiconductor layer 154h. The second gate electrode 124l, the second source electrode 173l, and the second drain electrode 175l form a second thin film transistor Ql together with the second semiconductor layer 154l. The third gate electrode 124c, the third source electrode 173c, and the third drain electrode 175c form a third thin film transistor Qc together with the third semiconductor layer 154c.

The first semiconductor layer 154h, the second semiconductor layer 154l, and the third semiconductor layer 154c may be connected to each other to thereby be linearly formed, and have a plane shape substantially equal to those of the data conductors 171, 173h, 173l, 173c, 175h, 175l, and 175c and ohmic contacts below the data conductors except for channel regions between the source electrodes 173h, 173l, and 173c, and the drain electrodes 175h, 175l, and 175c.

A portion that is not covered by the first source electrode 173h and the first drain electrode 175h but exposed between the first source electrode 173h and the first drain electrode 175h is present in the first semiconductor layer 154h. A portion that is not covered by the second source electrode 173l and the second drain electrode 175l but exposed between the second source electrode 173l and the second drain electrode 175l is present in the second semiconductor layer 154l. A portion that is not covered by the third source electrode 173c and the third drain electrode 175c but exposed between the third source electrode 173c and the third drain electrode 175c is present in the third semiconductor layer 154c.

A first passivation layer 180 is formed on the data conductors 171, 173h, 173l, 173c, 175h, 175l, and 175c, and the semiconductor layers 154h, 154l, and 154c exposed between each of the source electrodes 173h, 173l, 173c and the drain electrodes 175h, 175l, and 175c. The first passivation layer 180 may be made of an organic or inorganic insulating material and be formed of a single layer or multilayer.

A color filter 230 is formed in each of the pixels PX on the first passivation layer 180. Each of the color filters 230 may display one of primary colors such as three primary colors of red, green, and blue, and the like. The color filter 230 is not limited to displaying the three primary colors of red, green, and blue but may display cyan, magenta, yellow, and white-based colors. Unlike shown, the color filter 230 may be extended to be long between adjacent data lines 171.

A light blocking member 220 is positioned in a region between adjacent color filters 230. The light blocking member 220 may be formed on a boundary portion of the pixels PX and the thin film transistor to prevent a light leakage. The color filter 230 may be positioned in each of the first and second subpixels PXa and PXb, and the light blocking member 220 may be positioned between the first and second subpixels PXa and PXb.

The light blocking member 220 includes a horizontal light blocking member 220a extended along the gate line 121 and the decompression gate line 123 to thereby be expanded upwardly and downwardly and covering a region in which the first thin film transistor Qh, the second thin film transistor Ql, the third thin film transistor Qc, and the like, are positioned. The light blocking member 220 also includes a vertical light blocking member 220b extended along the data line 171. That is, the horizontal light blocking member 220a may be formed in the first valley V1, the vertical light blocking member 220b may be formed in the second valley V2. The color filter 230 and the light blocking member 220 may overlap with each other in some region.

A second passivation layer 240 may be further positioned on the color filter 230 and the light blocking member 220. The second passivation layer 240 may be made of an inorganic insulating material such as silicon nitride (SiNx), silicon oxide (SiOx), silicon oxynitride (SiOxNy), or the like. The second passivation layer 240 serves to protect the color filter 230 made of organic materials and the light blocking member 220, and if necessary, the second passivation layer 240 may be omitted.

A plurality of first and second contact holes 185h and 185l exposing the wide end portions of the first and second drain electrodes 175h and 175l are positioned in the second passivation layer 240, the light blocking member 220, and first passivation layer 180.

A pixel electrode 191 is positioned on the second passivation layer 240. The pixel electrode 191 may be made of a transparent metal material such as indium tin oxide (ITO), indium zinc oxide (IZO), or the like.

The pixel electrode 191 includes a first subpixel electrode 191h and a second subpixel electrode 191l separated from each other, having the gate line 121 and the decompression gate line 123 therebetween, and disposed at upper and lower portions of the pixel PX based on the gate line 121 and the decompression gate line 123 to thereby be adjacent to each other in the extension direction of the data line. That is, the first subpixel electrode 191h and the second subpixel electrode 191l are separated from each other, having the first valley V1 therebetween, and the first subpixel electrode 191h is positioned in the first subpixel PXa, and the second subpixel electrode 191l is positioned in the second subpixel PXb.

The first subpixel electrode 191h and the second subpixel electrode 191l are connected to the first and second drain electrodes 175h and 175l through the first and second contact holes 185h and 185l, respectively. Therefore, when first thin film transistor Qh and the second thin film transistor Ql are in an on-state, the first subpixel electrode 191h and the second subpixel electrode 191l are applied with a data voltage from the first and second drain electrodes 175h and 175l.

The first subpixel electrode 191h and the second subpixel electrode 191l have an overall rectangular shape and include cross-shaped stem portions composed of horizontal stem portions 193h and 193l and vertical stem portions 192h and 192l intersecting the horizontal stem portions 193h and 193l, respectively. In addition, the first subpixel electrode 191h and the second subpixel electrode 191l include a plurality of minute branch portions 194h and 194l and protrusion portions 197h and 197l protruding downwardly or upwardly from edge sides of the subpixel electrodes 191h and 191l, respectively.

The pixel electrode 191 is divided into four sub-regions by the horizontal stem portions 193h and 193l and the vertical stem portions 192h and 192l. The minute branch portions 194h and 194l are obliquely extended from the horizontal stem portions 193h and 193l and the vertical stem portions 192h and 192l, and an extension direction thereof may be formed to have an angle of about 45° or 135° with respect to the gate line 121 or the horizontal stem portions 193h and 193l. In addition, extension directions of minute branch portions 194h and 194l in adjacent two sub-regions may be orthogonal to each other.

The disposition form of the pixels, the structure of the thin film transistor, and the shape of the pixel electrode as described above are provided only by way of example, and the present disclosure is not limited thereto, but may be variously modified.

The common electrode 270 is positioned on the pixel electrode 191 so as to be spaced apart from the pixel electrode 191 by a predetermined distance. A cavity 305 distinguished by the pixel electrode 191, the common electrode 270, and a pillar portion 301 is formed. That is, the cavity 305 is enclosed by the pixel electrode 191, the common electrode 270, and the pillar portion 301 (FIG. 3). A width and an area of the cavity 305 may be variously changed depending on a size and resolution of the display device.

The pillar portion 301 is positioned between adjacent pixels PX and formed in the cavity 305 in the extension direction of the data line. That is, the pillar portion 301 is formed at a position corresponding to the second valley V2.

Each of the pillar portions 301 distinguishes a region of each of the pixels PX, and serves as a pillar supporting the roof layer 360 positioned on the cavity 305.

The pillar portion 301 may sufficiently support the roof layer 360 in a state in which negative photo resist is hardened by a light irradiation and hardening process.

A cross section of the pillar portion 301 in the extension direction of the gate line may have a tapered shape. Therefore, a cross section of the cavity 305 in the extension direction of the gate line has a reversely tapered shape, that is, the cavity 305 has a wider area on a top portion adjacent common electrode 270 than on a bottom portion adjacent pixel electrode 191.

The common electrode 270 may be made of a transparent metal material such as indium tin oxide (ITO), indium zinc oxide (IZO), or the like. A predetermined voltage may be applied to the common electrode 270, and an electric field may be formed between the pixel electrode 191 and the common electrode 270.

A first alignment layer 11 may be positioned on the pixel electrode 191. The first alignment layer 11 may be formed directly on the second passivation layer 240 that is not covered by the pixel electrode 191.

A second alignment layer 21 is positioned under the common electrode 270 so as to face the first alignment layer 11.

The first alignment layer 11 and the second alignment layer 21 may be formed of a vertical alignment layer and made of an alignment material such as polyamic acid, polysiloxane, polyimide, or the like. The first and second alignment layers 11 and 21 may be connected to each other at an edge of the pixel PX.

A liquid crystal layer made of liquid crystal molecules 310 is formed in the cavity 305 positioned between the pixel electrode 191, the common electrode 270, and the pillar portion 301. The liquid crystal molecules 310 have negative dielectric anisotropy, and may be erected in a direction vertical to the substrate 110 in a state in which the electric field is not applied. That is, vertical alignment may be performed.

The first and second subpixel electrodes 191h and 191l applied with a data voltage form an electric field together with the common electrode 270, thereby determining a direction of the liquid crystal molecules 310 positioned in the cavity 305 between two electrodes 191 and 270. Luminance of light passing through the liquid crystal layer is changed depending on the direction of the liquid crystal molecules 310, determined as described above.

The roof layer 360 is positioned on the second alignment layer 21. The roof layer 360 may be made of an organic material. The cavity 305 is positioned under the roof layer 360, and the roof layer 360 is hardened by the hardening process, thereby making it possible to maintain a shape of the cavity 305. That is, the roof layer 360 is formed so as to be spaced apart from the pixel electrode 191, having the cavity 305 therebetween.

The roof layer 360 is formed on each of the pixels PX and second valley V2 along the pixel rows and is not formed on the first valley V1. That is, the roof layer 360 is not formed between the first and second subpixels PXa and PXb and between adjacent pixels. The cavity 305 is positioned under each of the roof layers 360 in the first and second subpixels PXa and PXb. The pillar portion 301 is positioned under the roof layer 360 in the second valley V2. Therefore, the roof layer 360 may be formed to have the same thickness in an entire region in which the roof layer 360 is formed. That is, the cavity 305 is formed in a shape in which an upper surface thereof is covered by the roof layer 360 and both side surfaces thereof are blocked by the pillar portion 301.

This is in order to solve a problem that generally, in the case of a liquid crystal display device of which both side surfaces of a cavity 305 are covered by a roof layer 360, a taper having a predetermined angle is formed during a forming process of the roof layer 360, but a portion in which the taper is formed as described above cannot but become a non-transmitting region due to a difficulty in smooth movement of liquid crystal molecules positioned in this portion.

Because the roof layers 360 are not positioned in a first valley region, the roof layers 360 are spaced apart from each other, having the first valley region therebetween. Therefore, the roof layer 360 in a region adjacent to the valley region has an inclined surface.

Injection holes 307 (FIG. 10) exposing some of the cavity 305 are formed in the common electrode 270 and the roof layer 360. The injection holes 307 may be formed at edges of the first and second subpixels PXa and PXb so as to face each other. That is, the injection holes 307 may be formed so as to expose side surfaces of the cavity 305 corresponding to a lower side of the first subpixel PXa and an upper side of the second subpixel PXb. Because the cavity 305 is exposed by the injection hole 307, an alignment agent, a liquid crystal material, or the like, may be injected into the cavity 305 through the injection hole 307.

An overcoat 390 is positioned on the roof layer 360. The overcoat 390 is formed so as to cover the injection hole 307 exposing some of the cavity 305 to the exterior. That is, the overcoat 390 may seal the cavity 305 so that the liquid crystal molecules 310 formed in the cavity 305 are not discharged to the exterior of the cavity. Because the overcoat 390 comes in contact with the liquid crystal molecules 310, it is preferable that the overcoat 390 is made of a material that does not react with the liquid crystal molecules 310. For example, the overcoat 390 may be made of parylene, or the like.

The overcoat 390 may be formed of multiple layers such as a double layer, a triple layer, or the like. The double layer is composed of two layers made of different materials. The triple layer is composed of three layers, and materials of adjacent layers are different from each other. For example, the overcoat 390 may include a layer made of an organic insulating material and a layer made of an inorganic insulating material.

Although not shown, a polarizer may be further formed on upper and lower surfaces of the display device. The polarizer may be composed of first and second polarizers. The first polarizer may be attached to a lower surface of the substrate 110, and the second polarizer may be attached onto the overcoat 390.

In the liquid crystal display device as described above, a spaced distance between the common electrode and the pixel electrode may be constantly maintained, such that a constant electric field may be formed. That is, arrangement of the liquid crystal molecules by the electric field of the common electrode and the pixel electrode may be constant.

Further, in the liquid crystal display device according to an exemplary embodiment, a cavity having a uniform and constant shape may be provided, such that display quality may be improved. That is, formation of wrinkles or curves generated during a heating process may be controlled due to heat resistance improved by the negative photo resist, such that liquid crystal molecules having uniform arrangement may be provided.

In addition, because the liquid crystal display device according to an exemplary embodiment includes the reversibly tapered cavity, a region blocked by a tapered region is small, such that an aperture ratio of the display device may also be improved.

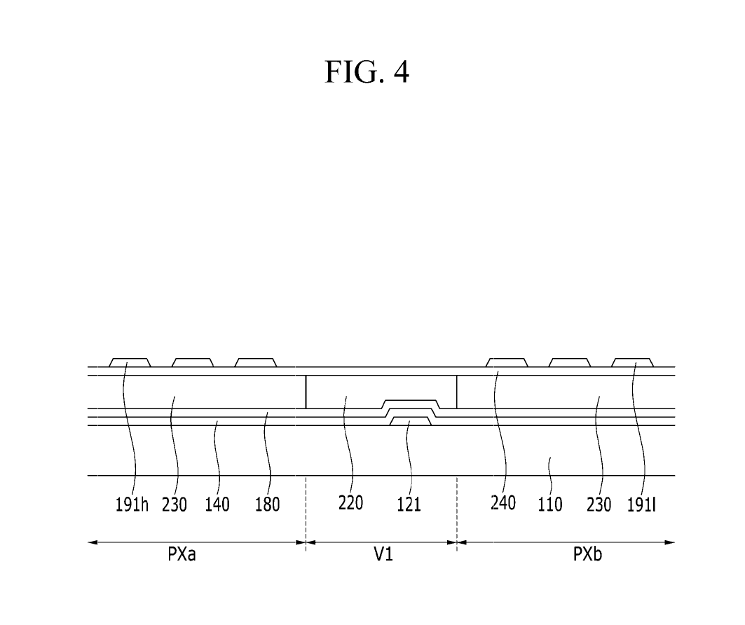

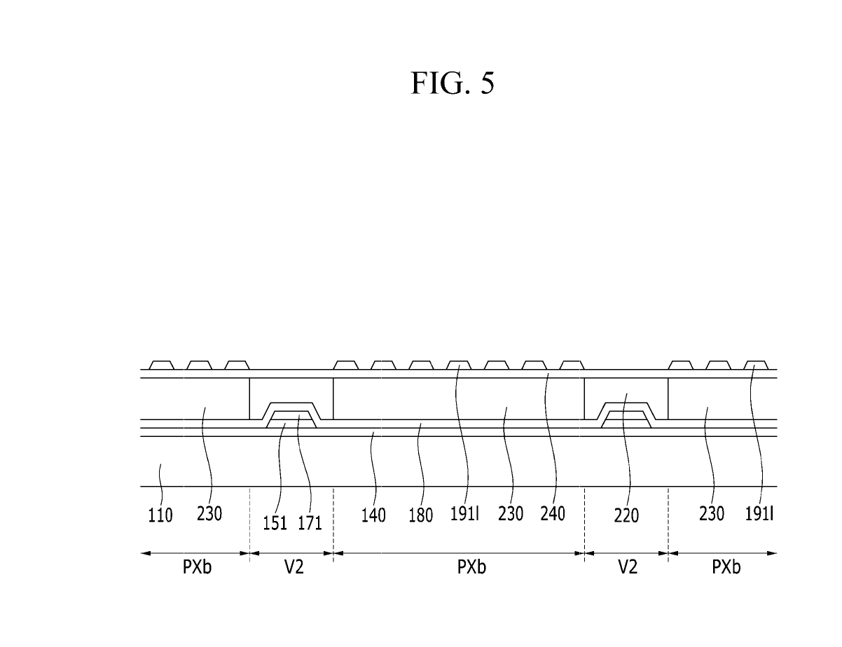

Hereinafter, a method of manufacturing a liquid crystal display device according to an exemplary embodiment will be described with reference to FIGS. 4 to 11. FIGS. 4, 6, 8, and 10 are cross-sectional views taken along line II-II of FIG. 1 according to the process, and FIGS. 5, 7, 9, and 11 are cross-sectional views taken along line III-III of FIG. 1.

First, as shown in FIG. 4, a gate line 121 along with a decompression gate line 123 extended in one direction and a first gate electrode 124h, a second gate electrode 124l, and a third gate electrode 124c protruding from the first gate line 121 (as shown in FIG. 1) are formed on an insulating substrate 110 made of glass, plastic, or the like.

In addition, a storage electrode line 131 (as shown in FIG. 1) may be simultaneously formed so as to be spaced apart from the gate line 121, the decompression gate line 123, and the first to third gate electrodes 124h, 124l, and 124c.

Then, a gate insulating layer 140 is formed on an entire surface of the insulating substrate 110 on which the gate line 121, the decompression gate line 123, the first to third gate electrodes 124h, 124l, and 124c, and the storage electrode line 131 are positioned using an inorganic insulating material such as silicon oxide (SiOx), silicon nitride (SiNx), or the like. The gate insulating layer 140 may be formed of a single layer or multiple layers.

Subsequently, a semiconductor layer (FIG. 5), which may include a first semiconductor layer 154h, a second semiconductor layer 154l, and a third semiconductor layer 154c (as shown in FIG. 1) are formed by depositing a semiconductor material such as amorphous silicon, polycrystalline silicon, metal oxide, or the like, on the gate insulating layer 140 and patterning the deposited semiconductor material. The first semiconductor layer 154h is formed to be positioned on the first gate electrode 124h, the second semiconductor layer 154l is formed to be positioned on the second gate electrode 124l, and the third semiconductor layer 154c is formed to be positioned on the third gate electrode 124c.

Next, a data line 171 (FIG. 5) extended in another direction is formed by depositing a metal material and patterning the deposited metal material. The metal material may be formed of a single layer or multiple layers.

In addition, a first source electrode 173h protruding upwardly of the first gate electrode 124h and a first drain electrode 175h spaced apart from the first source electrode 173h are formed together with each other from the data line 171. Further, a second source electrode 173l connected to the first source electrode 173h and a second drain electrode 175l spaced apart from the second source electrode 173l are formed together with each other. In addition, a third source electrode 173c extended from the second drain electrode 175l and a third drain electrode 175c spaced apart from the third source electrode 173c are formed together with each other.

The first to third semiconductor layers 154h, 154l, and 154c, the data line 171, the first to third source electrodes 173h, 173l, and 173c, and the first to third drain electrodes 175h, 175l, and 175c may be formed by continuously depositing the semiconductor material and the metal material and simultaneously patterning the deposited semiconductor and metal materials. In this case, the first semiconductor layer 154h may be formed to be extended to a lower portion of the data line 171. The first, second, and third gate electrodes 124h, 124l, and 124c, the first, second, and third source electrodes 173h, 173l, and 173c, and the first, second, and third drain electrodes 175h, 175l, and 175c configure first, second, and third thin film transistors (TFT) Qh, Ql, and Qc together with the first, second, and third semiconductor layers 154h, 154l, and 154c, respectively.

Then, a first passivation layer 180 is formed on the data line 171, the first to third source electrodes 173h, 173l, and 173c, the first to third drain electrodes 175h, 175l, and 175c, and the semiconductor layers 154h, 154l, and 154c exposed between each of the source electrodes 173h, 173l, and 173c and each of the drain electrodes 175h, 175l, and 175c. The first passivation layer 180 may be made of an organic or inorganic insulating material and be formed of a single layer or multiple layers.

Thereafter, a color filter 230 is formed in each of the pixels PX on the first passivation layer 180. The color filter 230 may be formed in the first and second subpixels PXa and PXb and may not be formed in a first valley V1. In addition, color filters 230 having the same color may be formed in an extension direction of the data lines of a plurality of pixels PX. In the case of forming color filters 230 having three colors, first, a color filter 230 having a first color is formed, and then, a color filter 230 having a second color may be formed by shifting a mask. Then, a color filter 230 having a third color may be formed by shifting the mask after forming the color filter 230 having the second color.

Next, a light blocking member 220 is formed on a boundary portion of each of the pixels PX and the thin film transistors on the first passivation layer 180. The light blocking member 220 may also be formed on the first valley V1 positioned between the first and second subpixels PXa and PXb.

Subsequently, a second passivation layer 240 is formed on the color filter 230 and the light blocking member 220 using an inorganic insulating material such as silicon nitride (SiNx), silicon oxide (SiOx), silicon oxynitride (SiOxNy), or the like.

The case in which the second passivation layer 240 is formed after forming the color filter 230 and then forming the light blocking member 220 is described in the above-mentioned exemplary embodiment, but the present disclosure is not limited thereto. If necessary, for example, after forming the light blocking member 220 first, the color filter 230 may be formed. Alternatively, after forming the color filter 230 and then forming the second passivation layer 240, the light blocking member 220 may be formed.

Next, the first passivation layer 180, the light blocking member 220, and the second passivation layer 240 are etched, such that a first contact hole 185h is formed so that some of the first drain electrode 175h is exposed, and a second contact hole 185l is formed so that some of the second drain electrode 175l is exposed.

Then, first and second subpixel electrodes 191h and 191l are formed in the first and second subpixels PXa and PXb, respectively, by depositing a transparent metal material such as indium tin oxide (ITO), indium zinc oxide (IZO), or the like, on the second passivation layer 240 and then patterning the deposited transparent metal material. The first and second subpixel electrodes 191h and 191l are separated from each other, having the first valley V1 therebetween. The first subpixel electrode 191h is formed so as to be connected to the first drain electrode 175h through the first contact hole 185h, and the second subpixel electrode 191l is formed so as to be connected to the second drain electrode 175l through the second contact hole 185l.

Horizontal stem portions 193h and 193l and vertical stem portions 192h and 192l intersecting the horizontal stem portions 193h and 193l are formed in the first and second subpixel electrodes 191h and 191l, respectively. In addition, a plurality of minute branch portions 194h and 194l obliquely extended from the horizontal stem portions 193h and 193l and the vertical stem portions 192h and 192l are formed.

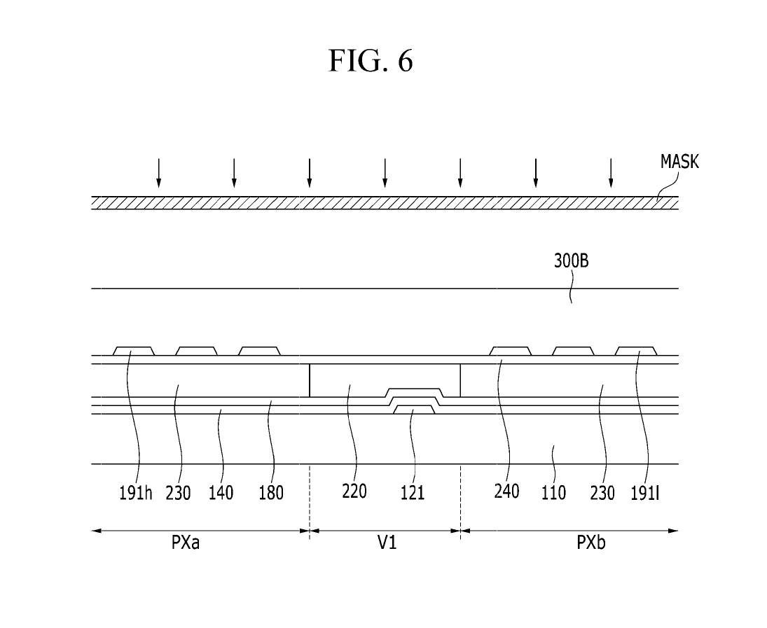

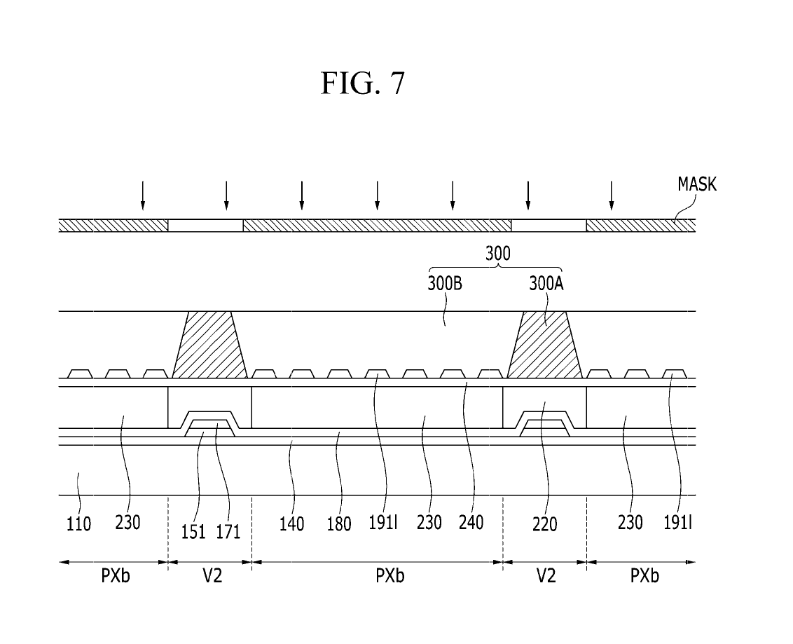

Next, as shown in FIGS. 6 and 7, a negative photo resist is applied on the pixel electrode 191, thereby forming a sacrificial layer 300. In this case, the sacrificial layer 300 may contain a compound represented by the following Chemical Formula 2.

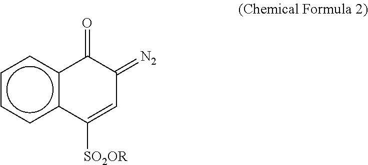

In addition, the negative photo resist may include a photo resist represented by the following Chemical Formula 4. The photo resist represented by the following Chemical Formula 4 may be DNQ-4-sulfonyl chloride.

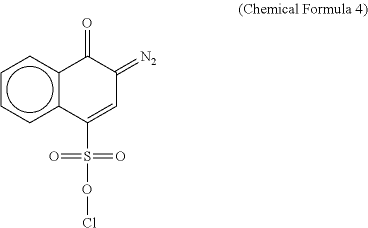

The sacrificial layer 300 is formed on the entire surface of the plurality of pixels PX. That is, the sacrificial layer 300 is formed so as to entirely cover each of the pixels PX, the first valleys V1 positioned between the first and second subpixels PXa and PXb, and the second valleys V2 positioned between a plurality of pixels PX adjacent to each other in the extension direction of the gate line.

Then, a mask capable of exposing a second valley V2 region between the pixels PX adjacent to each other in the extension direction of the gate line and a region 300A in which a pillar portion 301 will be formed is positioned over the entire surface of the insulating substrate 110.

Thereafter, light irradiation is performed on the sacrificial layer region 300A that is positioned in a second valley V2 portion and will become the pillar portion 301 by primary light irradiation using ultraviolet (UV) light. The region 300A to become the pillar portion is soluble by the process as described above. Particularly, the sacrificial layer region 300A to become the pillar portion 301 by the primary light irradiation may contain a compound represented by the following Chemical Formula 3.

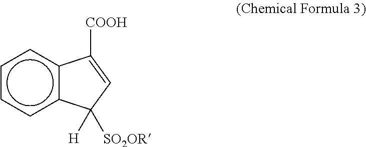

Next, a heating process is performed on the entire surface of the insulating substrate 110. According to the heating process as described above, the region 300A to become the pillar portion 301 may contain a compound in which compounds represented by the following Chemical Formula 1 are connected to each other. That is, the compounds represented by Chemical Formula 1 are connected to each other to form a stronger bond.

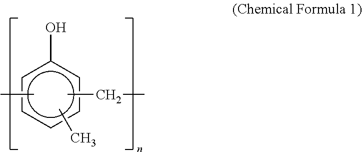

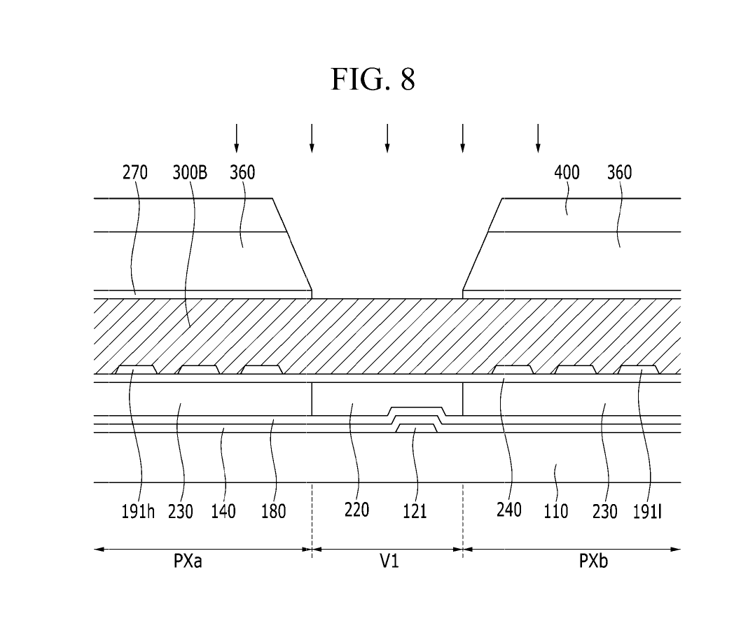

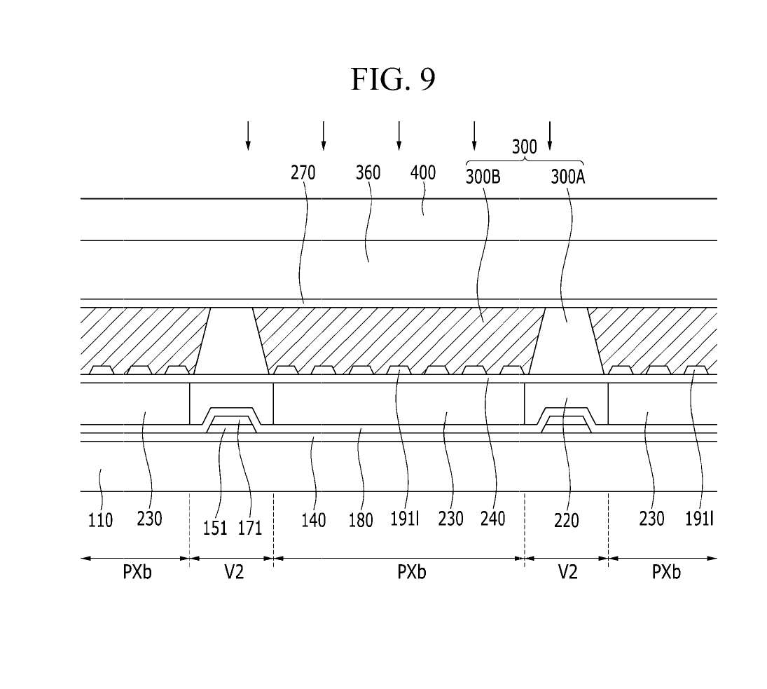

Then, as shown in FIGS. 8 and 9, a transparent metal conductor such as indium tin oxide (ITO), indium zinc oxide (IZO), or the like, is deposited on the sacrificial layer 300. Subsequently, an organic material is applied on an entire surface of the metal conductor.

Next, a photo resist 400 is applied and developed on the organic material to form a roof layer 360, and a common electrode 270 is formed by etching the metal conductor using the photo resist as a mask.

Next, secondary light irradiation is performed on the entire surface of the insulating substrate 110. In this light irradiation, the region 300A to become the pillar portion 301 and including a state in which the compounds represented by Chemical Formula 1 are connected to each other is not affected by the secondary light irradiation. On the contrary, a region 300B except for the pillar portion 301 becomes soluble. A material of the region 300B except for the pillar portion may contain a compound represented by the following Chemical Formula 3. That is, the material is changed from a compound material represented by Chemical Formula 2 into a compound material represented by the following Chemical Formula 3.

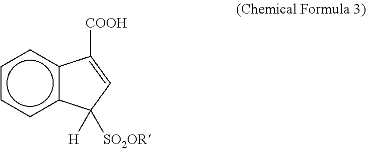

Thus, the initially applied sacrificial layer 300 contains the compound represented by Chemical Formula 2.

The compound in the region 300A to become the pillar portion 301 is changed into the compound represented by Chemical Formula 3 by primary light irradiation, and this region is soluble. However, the region 300A is then changed into a state in which the compounds represented by Chemical Formula 1 are connected to each other by the heating process, and a connection relationship or state thereof is not changed by the subsequently performed secondary light irradiation. The region in the state in which the compounds represented by Chemical Formula 1 are connected to each other is insoluble.

Because all of the regions 300B except for the region to become the pillar portion 301 are not subjected to light irradiation due to the mask in the primary light irradiation, the region 300B contains the compound represented by Chemical Formula 2, and there is no change in state during the subsequently performed heating process. Then, the compound represented by Chemical Formula 2 is changed into the compound represented by Chemical Formula 3 having solubility by the secondary light irradiation performed on the entire surface of the substrate.

That is, when the primary light irradiation, the heating process, and the secondary light irradiation are completed, the region 300A to become the pillar portion 301 is insoluble, but the region 300B except for the region 300A is soluble.

Therefore, as shown in FIGS. 10 and 11, when a developer is injected on the insulating substrate 110 on which the sacrificial layer 300 is exposed, the region 300B that is soluble is entirely removed. That is, the region 300A that is not developed due to insolubility thereof forms the pillar portion 301, and a cavity 305 is formed in a space in which the other sacrificial layer 300B was positioned.

The pixel electrode 191 and the common electrode 270 are spaced apart from each other, having the cavity 305 therebetween, and the pixel electrode 191 and the roof layer 360 are spaced apart from each other, having the cavity 305 therebetween. The cavity 305 has a shape in which an upper surface thereof is covered by the common electrode 270 and the roof layer 360, and both side surfaces thereof are blocked by the pillar portion 301.

The cavity 305 is exposed to the exterior through a portion on which the roof layer 360 and the common electrode 270 are removed, and this portion is referred to as an injection hole 307. The injection hole 307 is formed along the first valley V1. For example, the injection holes 307 may be formed at edges of the first and second subpixels PXa and PXb so as to face each other. That is, the injection holes 307 may be formed so as to expose side surfaces of the cavity 305 corresponding to a lower side of the first subpixel Pxa and an upper side of the second subpixel PXb. Unlikely, the injection hole 307 may be formed along the second valley V2.

Next, heat is applied to the insulating substrate 110 to harden the roof layer 360. The reason is to allow a shape of the cavity 305 by the roof layer 360 to be maintained.

Then, when an alignment agent containing an alignment material is dropped on the substrate 110 by a spin coating method or inkjet method, the alignment agent is injected into the cavity 305 through the injection hole 307. In the case of performing a hardening process after injecting the alignment agent into the cavity 305, a solution component is evaporated, and the alignment material remains in a wall surface in the cavity 305.

Therefore, a first alignment layer 11 may be formed on the pixel electrode 191, and a second alignment layer 21 may be formed under the common electrode 270. The first and second alignment layers 11 and 21 may be formed so as to face each other, having the cavity 305 therebetween and may be connected to each other at edges of the pixel PX.

Here, in the first and second alignment layers 11 and 21 except for side surfaces of the cavity 305, alignment may be performed in a direction vertical to the substrate 110. Alignment may be performed in a direction parallel with the substrate 110 by additionally performing an UV irradiation process on the first and second alignment layers 11 and 21.

Subsequently, when a liquid crystal material composed of liquid crystal molecules 310 is dropped on the substrate 110 by an inkjet method or dispensing method, the liquid crystal material is injected into the cavity 305 through the injection hole 307. At this time, the liquid crystal material may be dropped into injection holes 307 formed along odd-numbered first valleys V1 and may not be dropped into injection holes 307 formed along even-numbered first valleys V1. On the contrary, the liquid crystal material may be dropped into the injection holes 307 formed along the even-numbered first valleys V1 and may not be dropped into the injection holes 307 formed along the odd-numbered first valleys V1.

In the case of dropping the liquid crystal material into the injection holes 307 formed along the odd-numbered first valleys V1, the liquid crystal material passes through the injection holes 307 by capillary force to thereby be put into the cavity 305. In this case, air in the cavity 305 is discharged through the injection holes 307 formed along the even-numbered first valleys V1, such that the liquid crystal material is put into the cavity 305.

In addition, the liquid crystal material may be dropped into all of the injection holes 307. That is, the liquid crystal material may be dropped into all of the injection holes 307 formed along the odd-numbered first valleys V1 and the injection holes 307 formed along the even-numbered first valleys V1.

The overcoat 390 (shown in FIGS. 2 and 3) is formed by depositing a material that does not react with the liquid crystal molecules 310 on the roof layer 360 and the injection hole 307. The overcoat 390 is formed so as to cover the injection hole 307 through which the cavity 305 is exposed to the outside, thereby sealing the cavity 305. The liquid crystal display device according to the above-mentioned process has cross sections shown in FIGS. 2 to 3.

Next, although not shown, a polarizer may be further attached to upper and lower surfaces of the display device. The polarizer may be composed of first and second polarizers. The first polarizer may be attached to a lower surface of the substrate 110, and the second polarizer may be attached onto the overcoat 390.

In the liquid crystal display device as described above, a spaced distance between the common electrode and the pixel electrode may be constantly maintained, such that a constant electric field may be formed. That is, arrangement of the liquid crystal molecules by the electric field of the common electrode and the pixel electrode may be constant.

Further, in the liquid crystal display device according to an exemplary embodiment, a cavity having a uniform and constant shape may be provided, such that display quality may be improved. That is, formation of wrinkles or curves generated in the cavity during a heating process may be controlled due to heat resistance improved by the negative photo resist, such that liquid crystal molecules having uniform arrangement may be provided.

In addition, because the liquid crystal display device according to an exemplary embodiment includes the reversibly tapered cavity, a region blocked by a tapered region is small, such that an aperture ratio of the display device may also be improved.

Hereinabove, although exemplary embodiments are described in detail, the scope of the present invention is not limited thereto, and various modifications and reformations by a person of an ordinary skill in the art using a basic concept of the present invention defined in the claims are also included within the spirit and scope of the disclosure, including the appended claims.

<Description of symbols>
11: first alignment layer
21: second alignment layer
110: insulating substrate
121: gate line
124h: first gate electrode
124l: second gate electrode
124c: third gate electrode
131: storage electrode line
140: gate insulating layer
171: data line
180: first passivation layer
191: pixel electrode
360: roof layer
390: overcoat

What is claimed is:

1. A liquid crystal display device comprising:
an insulating substrate,
a gate line and a data line positioned on the insulating substrate, and insulated from and intersecting each other,
a thin film transistor connected to the gate line and the data line,
a color filter and a light blocking member positioned on the thin film transistor,
a pixel electrode positioned on the color filter and connected to the thin film transistor,
a pillar portion positioned on the pixel electrode,
a common electrode positioned on the pillar portion,
a liquid crystal layer filling in a cavity positioned between the pixel electrode, the pillar portion, and the common electrode and containing liquid crystal molecules, and
a roof layer and an overcoat positioned on the common electrode,
wherein a cross section of the cavity in an extension direction of the gate line is reversely tapered.

2. The liquid crystal display device of claim 1, wherein:
a single pixel includes the thin film transistor and the pixel electrode, and
the pillar portion is positioned along the data line in the single pixel.

3. The liquid crystal display device of claim 1, wherein:
a cross section of the pillar portion in the extension direction of the gate line is tapered.

4. The liquid crystal display device of claim 1, wherein:
the common electrode and the pixel electrode are spaced apart and separated from each other by the pillar portion.

5. The liquid crystal display device of claim 4, wherein:
a material of the pillar portion contains a compound in which compounds represented by the following Chemical Formula 1 are connected to each other:

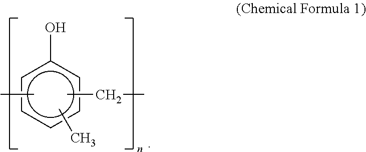

6. The liquid crystal display device of claim 1, wherein:
materials of the pillar portion and the roof layer are different from each other, and the pillar portion is a negative photo resist.

7. A method of manufacturing a liquid crystal display device, the method comprising:
forming a thin film transistor on an insulating substrate,
forming a pixel electrode connected to the thin film transistor,
forming a sacrificial layer on the pixel electrode,
performing primary light irradiation on a region of the sacrificial layer to become a pillar portion,
heating an entire surface of the sacrificial layer,
depositing a conductor on the sacrificial layer,
forming a roof layer including an injection hole on the conductor,
etching the conductor using the roof layer as a mask to form a common electrode,
performing secondary light irradiation on an entire surface of the roof layer,
developing the exposed sacrificial layer and injecting liquid crystal molecules through the injection hole, and
forming an overcoat covering the roof layer and the injection hole,
wherein the pillar portion becomes insoluble by the heating process, and the sacrificial layer except for the pillar portion becomes soluble by the secondary light irradiation.

8. The method of claim 7, wherein:
the sacrificial layer before the primary light irradiation is a negative photo resist and contains a compound represented by the following Chemical Formula 2:

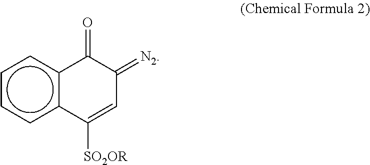

9. The method of claim 7, wherein:
the region to become the pillar portion becomes soluble by the primary light irradiation.

10. The method of claim 9, wherein:
the pillar portion contains a compound represented by the following Chemical Formula 3 after the primary light irradiation:

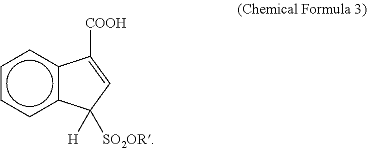

11. The method of claim 9, wherein:
in the pillar portion, compounds represented by the following Chemical Formula 1 are connected to each other by the heating process:

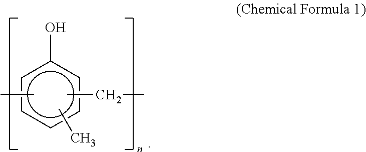

12. The method of claim 11, wherein:
the pillar portion after the heating process is insoluble.

13. The method of claim 11, wherein:
a material of the pillar portion is not changed by the secondary light irradiation, and
the sacrificial layer except for the pillar portion contains a compound represented by Chemical Formula 3.

14. The method of claim 13, wherein:
the sacrificial layer except for the pillar portion is soluble.

15. The method of claim 14, wherein:
the sacrificial layer except for the pillar portion is removed in the developing of the exposed sacrificial layer.
